(19) United States
(12) Patent Application Publication
(10) Pub. No.: US 2012/0182142 A1
(43) Pub. Date: Jul. 19, 2012

(54) WARNING SYSTEM AND METHOD FOR DETECTING A NEAR-ACCIDENT SITUATION IN CONNECTION WITH A WORKING AREA

(75) Inventors: Kjell Danielsson, Gagnef (SE); Leif Adolfsson, Borlange (SE)

(73) Assignee: ITSBRILLIANT AB, Gävle (SE)

(21) Appl. No.: 13/496,980

(22) PCT Filed: Sep. 14, 2010
(86) PCT No.: PCT/SE2010/050978

§ 371 Date: Mar. 19, 2012

(30) Foreign Application Priority Data
Sep. 17, 2009 (SE) 0950677-5

(51) Int. Cl. B60Q 1/00

(52) U.S. Cl. 340/435

(57) ABSTRACT

Method and system for detecting a near-accident situation in connection with a working area include a control system in which a digital representation of a working area is storable, at least part of the working area including a working field where work is intended to be carried out, elements for detecting a near-accident situation in connection with the working area and the type of the same, at least one actor appliance operatively connected with the control system and including a sensation device, and elements for establishing the position of the at least one actor appliance, the control system, in case a near-accident situation has been detected, being arranged to activate the sensation device of the at least one actor appliance if the position of the actor appliance is situated in a risk area established in the control system, which establishment is based on the type of the detected near-accident situation.

### TECHNICAL FIELD OF THE INVENTION

The present invention relates generally to a security system for persons present in various working environments with a high risk of accidents. In particular, the present invention relates to a system as well as a method for detecting a near-accident situation in connection with a working area, such as a working place on/along or adjacent to a road, a dock area, a construction site, etc.

### BACKGROUND OF THE INVENTION AND PRIOR ART

The background of the present invention is the admittedly unsafe working environment that characterizes working places arranged on/along or adjacent to larger and smaller roads, on which working places the staffs of the civil engineering firms carries out different kinds of works. Examples of such traffic environments are pavement works and operation and maintenance works. For workers who are on foot within the working area, maintenance vehicles as well as road-user vehicles constitute a risk, as the work carried out every now and then requires the full attention of the worker, and therefore concentration on the passing traffic from time to another is low. Also for workers who are in/on maintenance vehicles within the working area, road-user vehicles constitute a risk, in particular in those cases the road-user vehicles are heavy lorries or trucks. Simultaneously, the working environment that the workers are in is characterized as physically demanding in the form of strong noise and vibrations from maintenance vehicles as well as passing road-user vehicles. Accordingly, the possibility for a worker to distinguish and estimate a near-accident situation is small, which, in addition to the physically demanding working environment, also subjects the workers to a psychically trying working environment.

Nevertheless, the risks and safety problems associated with works on/along the road affect also the road-users, as maintenance vehicles often are present that are large and heavy, and that move in non-predetermined patterns. Besides, the possibility for the road-users to take in the working area and the manoeuvring space upon a possible near-accident is often highly limited. However, work on/along the road is above all seen as an obstacle by road-users, and road-users that approach and pass through a working area do not observe and/or obey the instructions and reduced speed limits that generally are associated with such works, because the road-users most often attaches value to their own progress before the safety and working environment of the staff, and also before their own safety.

An additional cause of at least a part of the near-accident situations that arise upon work on/along the road, in addition to the lack of overview and control of the passing traffic, may to a certain extent be explained by the lack of information between the vast majorities of persons present within the working area. Accordingly, near-accident situations arise also when road-user vehicles are not involved.

The staff thus needs external help to be warned in the case of a near-accident situation. However, warning systems for staff working on/along the road known today consist of crude and blunt warning systems, where one and the same warning of a risk of accident takes place over the entire working area irrespective of the type and location of the near-accident situation, which leads to blunting of the staff, which in turn entails that the individual worker risks to not obey the warning when real danger actually is imminent. Besides, such a system does not warn if only one individual worker, as a consequence of his/her own action, places himself/herself in an increased risk of becoming involved in a near-accident.

At an early stage of the development of the present invention, also other working areas, in addition to works on or adjacent to a road, were identified, which are distinguished by similar risks of accidents. These working areas are, for instance, docks, construction sites, industries, etc., where staff and maintenance vehicles move in non-predetermined patterns, and many various near-accident situations may thereby arise.

### BRIEF DESCRIPTION OF OBJECTS AND FEATURES OF THE INVENTION

The present invention aims at obviating the above-mentioned disadvantages and failings of previously known systems and at providing an improved system. A primary object of the invention is to provide an improved system of the type defined by way of introduction and arranged to only warn those actors who risk becoming involved in the near-accident situation that has caused the warning.

Another object of the present invention is to provide a system, from which warnings of different character and intensity can be sent out depending on the type of the near-accident situation.

Another object of the present invention is to provide a system that warns each individual worker separately based on the position of the same in relation to the near-accident situation that has caused the warning.

According to the invention, at least the primary object is achieved by means of the system defined by way of introduction and characterized in that the same comprises a control system in which a digital representation of a working area is storable, at least a part of the working area consisting of a working field in which work is intended to be carried out, means for the detection of a near-accident situation in connection with the working area and the type of the same, at least one actor appliance operatively connected with the control system and comprising a sensation device, as well as means for the establishment of the position of said at least one actor appliance, the control system, in case a near-accident situation has been detected, being arranged to activate the sensation device of said at least one actor appliance if the position of the actor appliance is situated in a risk area established in the control system, which establishment is based on the type of the detected near-accident situation.

Accordingly, the present invention is based on the understanding that only those actors who risk becoming involved in the near-accident situation that has caused the warning need to be warned in order not to blunt the workers' ability to act to save themselves, or temporary increase their attention on the surrounding traffic.

Preferred embodiments of the present invention are furthermore defined in the depending claims.

Preferably, said actor appliance consists of a personal appliance in which the means for the establishment of the position of the personal appliance consists of a positioning device comprised in the personal appliance.

Preferably, the sensation device of said at least one personal appliance consists of a vibrator unit, which entails that the worker is warned in an adequate way also when the working environment is distinguished by, for instance, noise and strong sunlight, heavy rain or snow, as well as fumes or dust.

According to a preferred embodiment, the system comprises at least one vehicle appliance operatively connected with the control system and comprising a positioning device.

According to a preferred embodiment, said means for the detection of a near-accident situation in connection with the working area and the type of the same consists of an algorithm that is included in the control system and that analyses, based on various input data, among other things with which probability a collision is inevitable and damage upon a collision.

In an additional preferred embodiment, said means for detection also consists of at least one radar appliance operatively connected with the control system and intended to establish position as well as the speed and/or direction of motion of road-user vehicles.

Preferably, the system also comprises at least one road-user appliance operatively connected with the control system and comprising at least one sensation device intended to warn the road-user involved in the near-accident situation.

The object of the invention is also achieved by means of the method defined by way of introduction and characterized by the steps of storing a digital representation of a working area in a control system, at least a part of the working area consisting of a working field in which work is intended to be carried out, positioning an actor appliance operatively connected with the control system, and detecting a near-accident situation in connection with the working area and the type of the same, the control system, in case a near-accident situation has been detected, activating a sensation device of said at least one actor appliance, if the position of the actor appliance is situated in a risk area established in the control system, which establishment is based on the type of the detected near-accident situation.

Additional advantages and features of the invention are seen in the other dependent claims as well as in the following, detailed description of preferred embodiments.

### BRIEF DESCRIPTION OF THE DRAWINGS

A more complete understanding of the above-mentioned and other features and advantages of the present invention will be clear from the following, detailed description of preferred embodiments, reference being made to the accompanying drawings, wherein:

FIG. 1 is a schematic view from above of a working area on/along a road,

FIG. 2 is a schematic view from above of the working area in FIG. 1, in which working area staff and vehicles are.

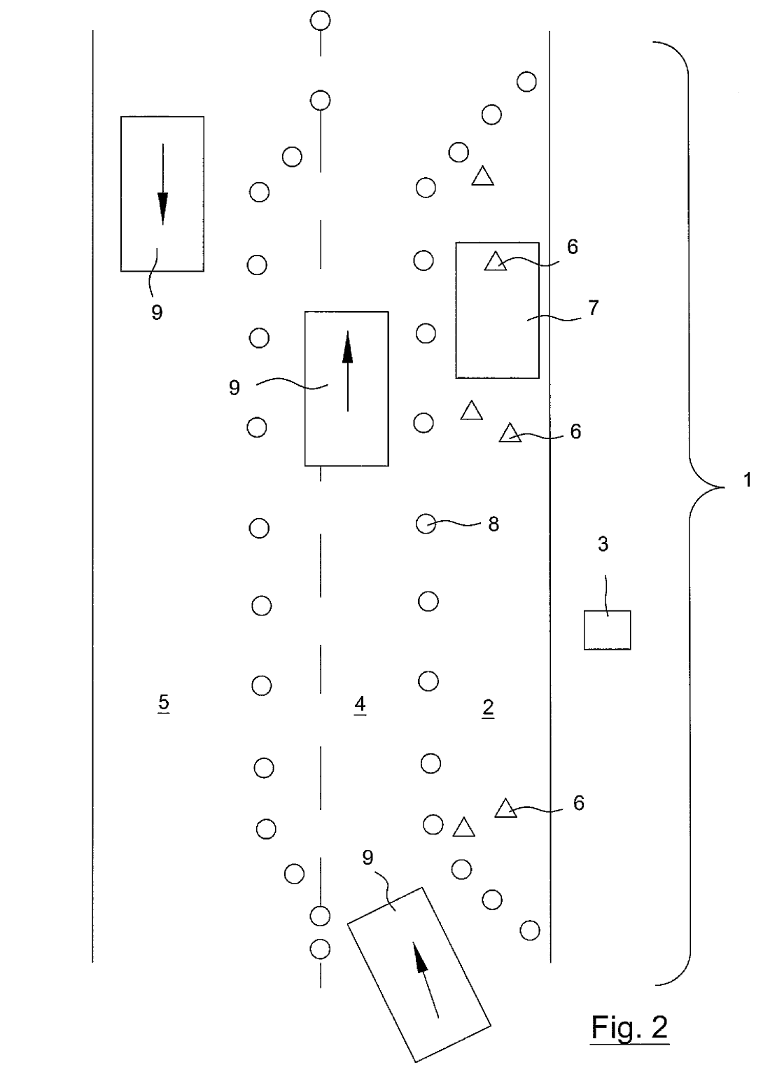

### DETAILED DESCRIPTION OF PREFERRED EMBODIMENTS

The present invention consists of a system for detecting a near-accident situation in connection with a working area, generally designated 1. By working area 1, herein, reference is made to a geographically delimited area within which authorized staff carries out a specific work. The working area 1 may, for instance, consist of a working place situated on/along or adjacent to a road, or situated in another traffic environment, to which unauthorized road-users (persons/vehicles) have or have not access, of a dock area, of a construction site, of an industrial park or estate, of a railway station or yard for handling cargo, etc. The working area 1 may in addition be of both stationary type and mobile/temporary type, as will be explained later. It should be emphasized that the physical outer border of the working area 1 does not necessarily have to be indicated by means intended therefor, even so this is generally the case. Besides, at least a part of the working area 1 should be a working field 2, within which the specific work is intended to be carried out. It should be emphasized that the physical outer border of the working field 2 does not necessarily have to be indicated by means intended therefor, even so this is generally the case. It should be mentioned that in certain cases, the entire working area 1 consists of said working field 2, which is the fact in, for instance, a dock area, an industrial park, a mobile/temporary working area, etc.

The present invention will now, for the sake of clarity, be described in connection with a working area 1 that consists of a stationary working place situated on/along a road, wherein reference will be made to the accompanying drawings, if nothing else is mentioned. However, the following description is not limited to only this type of working area 1, but the following description applies also to other types of working areas 1 as has been described above, or yet other types of working areas as will be described below.

### Control System

The system according to the invention for detecting a near-accident procedure in connection with a working area 1 comprises a control system 3 in which a digital representation of the working area 1 is storable. This digital representation consists preferably of a two-dimensional, alternatively a three-dimensional, model of the real working area 1 with the appurtenant working field 2. Alternatively, said digital representation may consist of a predetermined area in relation to the control system, irrespective of in which environment the control system is.

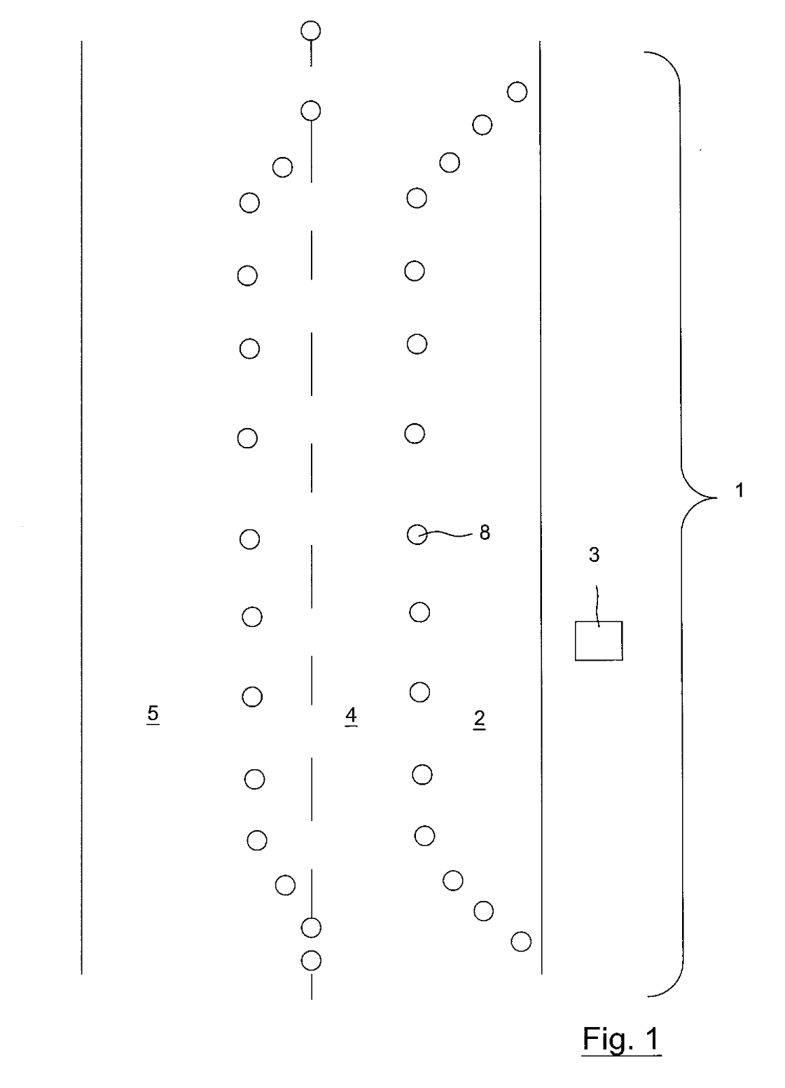

In FIG. 1, the working area 1 also comprises a first traffic lane 4 for the passing traffic and a second traffic lane 5 for the meeting traffic, which traffic lanes preferably also are seen in the digital representation of the working area 1. An advantage of utilizing a three-dimensional model of the working area 1 is that brows of hills, hidden curves, and the like are seen, which is not necessarily clear in a two-dimensional model. By three-dimensional model, reference is also made to a combination of two two-dimensional models, one taken from above and one taken from the side.

### Actor Appliance

Further, the system according to the invention comprises at least one actor appliance, not shown, operatively connected with the control system 3. The actor appliance comprises in turn a sensation device. The actor appliance may consist of a personal appliance and/or a vehicle appliance, which will be described below.

### Positioning Means

Besides, the system according to the invention comprises means for the establishment of the position of said at least one actor appliance. In the most basal embodiment, the means for the establishment of the position of said at least one actor appliance consists of information included in the control system 3, which information forms input data in the establishment of whether said at least one actor appliance is situated within a risk area established in the control system 3. Said information may manually or automatically be introduced into the control system and does not necessarily need to comprise data about the exact position of the actor appliance in question but may comprise data about within which part area, or which part areas, of the working area 1 that the present actor appliance will be positioned in, as well as during which periods of time, during the time the working area 1 is manned and work is intended to be carried out. Accordingly, the information may be introduced manually into the control system by personal appliances and vehicle appliances present for the day being registered. Alternatively, it is registered automatically when personal appliances and/or vehicle appliances enter into or exit from the working area 1. Said part area may be the entire working area 1. Preferably, said means for the establishment of the position of said at least one actor appliance consists of a positioning device comprised in the actor appliance, which will be explained in more detail below.

### Personal Appliance

Preferably, the system according to the invention comprises at least one personal appliance, not shown, operatively connected with the control system 3. The personal appliance comprises in turn a sensation device and preferably a positioning device, and is intended to be worn by the individual worker 6. By workers, herein, reference is made to all authorized staff present within the working area 1, irrespective of the task. Accordingly, during operation, the system according to the invention comprises the same number of personal appliances as the number of workers 6 present within the working area 1. It is preferred that the control system 3 automatically identifies and registers if a personal appliance arrives to or leaves the working area 1, but it is also feasible that registration/deregistration is made in a manual way by activation/deactivation of the individual personal appliance in connection with entry into and exit from, respectively, the working area 1.

The positioning device of the personal appliance, which, for instance, may consist of a positioning appliance known per se, which is arranged to utilize known local or global positioning systems, is arranged in such a way that it directly or indirectly communicates the position of the specific personal appliance in relation to the working field 2 and the working area 1 to the control system 3 in real-time, continuously or intermittently. Co-operation between the positioning device of the personal appliance and the control system 3 also entails that the direction and speed of motion of the personal appliance can be established in the control system 3. The communication may, for instance, be effected via known wireless communications technique, wired communications technique, fibreoptic communications technique, etc., which are used in, for instance, mobile telephone networks, radio communications networks and/or positioning systems. With the purpose of obtaining the best possible positioning of the personal appliances, preferably a reference positioning device operatively connected to the control system 3 is utilized, for the calibration of the system. In case the personal appliance does not comprise a positioning device, all actors present within the working area 1 may, for instance, be monitored and tracked by means of a radar appliance.

The sensation device of the personal appliance, which, for instance, may consist of a vibrator unit, is arranged to receive an activation signal from the control system in the event of the worker 6 who wears the specific personal appliance should be warned upon a detected near-accident situation. The sensation device should preferably be activatable at different alarm levels, which are interarranged along a relative, preferably rising, scale in line with the type of the near-accident and the position of the specific personal appliance. Besides, the sensation device can preferably also be activated by a specific activation upon, for instance, a functional test, etc. The personal appliance consists preferably of a wrist strap unit in which the positioning device and the sensation device are arranged together with a requisite power source to energize the same. In the preferred embodiment, the personal appliance is accordingly intended to be worn around the wrist of the worker 6. It should be pointed out that, in case the sensation device consists of a vibrator unit, the personal appliance may also consist of an ankle strap unit, collar unit, belt unit, etc., or be integrated in other suitable working clothes. However, the essential thing is that the sensation device in the form of a vibrator unit, when the same is activated by the control system 3, is perceived as being activated by the wearer.

It should be pointed out that the sensation device, as an alternative to or a complement to a vibrator unit, may consist of a light unit and/or a sound unit. In case the personal appliance comprises several types of sensation devices, the worker 6 can preferably himself/herself select which one of the same that should be activated upon receipt of an activation signal from the control system 3, with the purpose of giving the most adequate warning in view of the working environment in which the worker 6 at present is.

Preferably, the personal appliance also comprises an identification device, which is arranged to forward such information to the control system 3 that contributes to allow the control system 3 to identify the type of the specific worker 6, i.e., task, experience, etc. This information can be used, by the control system 3, for instance, to warn certain workers 6 more often or more rarely based on, for instance, the task and the experience of being positioned in a working area 1 situated on/along a road.

### Vehicle Appliance

According to the invention, the system preferably also comprises a vehicle appliance, not shown, operatively connected with the control system 3. The vehicle appliance, in turn, preferably comprises at least one positioning device, and is intended to be arranged in/on the individual maintenance vehicle 7. By maintenance vehicles, herein, reference is made to all authorized vehicles present within the working area 1, irrespective of the type and task. Accordingly, during operation, the system according to the invention comprises the same number of vehicle appliances as the number of maintenance vehicles 7 present within the working area 1. It should be pointed out that in case the specific maintenance vehicle 7 comprises, for instance, a traction vehicle and a towed vehicle, also the towed vehicle preferably comprises a positioning device. Besides, it should be pointed out that in case the specific maintenance vehicle 7 comprises, for instance, a crane arm or the like, the outer end of which can assume a position distanced from the proper maintenance vehicle 7, also the crane arm preferably comprises a positioning device. It is preferred that the control system 3 automatically identifies and registers if a vehicle appliance arrives to or leaves the working area 1, but it is also feasible that registration/deregistration is made in a manual way by activation/deactivation of the individual vehicle appliance in connection with entry into and exit from, respectively, the working area 1.

The positioning device of the vehicle appliance, which, for instance, may consist of a positioning appliance known per se that is arranged to utilize known local or global positioning systems, is arranged to directly or indirectly communicate the position of the specific vehicle appliance in relation to the working field 2 and the working area 1 to the control system 3 in real-time, continuously or intermittently. Co-operation between the positioning device of the vehicle appliance and the control system 3 also entails that the direction and speed of motion of the vehicle appliance can be established in the control system 3. The communication may, for instance, take place via known wireless communications technique, wired communications technique, fibre-optic communications technique, etc., which are used in, for instance, mobile telephone networks, radio communications networks and/or positioning systems. With the purpose of obtaining the best possible positioning of the vehicle appliances, a reference positioning device operatively connected to the control system 3 is preferably utilized for the calibration of the system. In case the vehicle appliance does not comprise a positioning device, all actors present within the working area 1 may, for instance, be monitored and tracked by means of a radar appliance.

The vehicle appliance may also comprise an identification device, which is arranged to forward such information to the control system 3 that contributes to allow the control system 3 to identify the type of the maintenance vehicle in question 7, i.e., size, weight, task, etc.

The vehicle appliance may also comprise at least one sensation device. The sensation device should preferably be activatable at different alarm levels, which are interarranged along a relative, preferably rising, scale in line with the type of the near-accident and the position of the specific personal appliance. Besides, the sensation device can preferably also be activated by a specific activation upon, for instance, a functional test, etc. A first type of sensation device in the vehicle appliance is intended to warn the possible worker 6 present in the specific maintenance vehicle 7 and then functions as a complement or alternative to the sensation device in the personal appliance of the worker 6. A second type of sensation device in the vehicle appliance is intended to warn possible workers 6 present in the immediate vicinity of the specific maintenance vehicle 7 and then also works as a complement or alternative to the sensation device in the personal appliance of the individual worker 6. This second type of sensation device in the vehicle appliance is primarily intended to be activated when a concrete and inevitable near-accident situation is imminent.

The sensation device of the vehicle appliance may consist of a light unit, a sound unit and/or a vibrator unit, and is arranged to receive an activation signal from the control system in case the maintenance vehicle 7 that carries the specific vehicle appliance should warn the worker/workers 6 upon a detected near-accident situation. The vehicle appliance is driven by a requisite power source, either a separate power source or an ordinary occurring power source in the maintenance vehicle 7. It should be pointed out that, in case the sensation device consists of a vibrator unit, the same may be situated in the driver's seat of the maintenance vehicle, or the like. However, the essential thing is that the sensation device in the form of a vibrator unit, when the same is activated by the control system 3, is perceived as being activated by the worker 6. However, a light unit or a sound unit is preferable, considering the vibrations that naturally are present in a maintenance vehicle 7.

In case the vehicle appliance comprises several types of sensation devices, the worker 6 who is in the specific maintenance vehicle 7 can preferably himself/herself select which one of the same that should be activated upon receipt of an activation signal from the control system 3, with the purpose of giving the most adequate warning in view of the working environment that the worker 6 and the maintenance vehicle 7 at present are in.

### Equipment Appliance

The system according to the invention preferably also comprises an equipment appliance, not shown, operatively connected with the control system 3. The equipment appliance comprises in turn a positioning device, and is intended to be arranged in equipment delimitation 8, such as a cone, or in other more or less stationary equipment present within the working area 1. By equipment, herein, reference is made to all authorized equipment present within the working area 1, irrespective of the type or task. However, it should be pointed out that all authorized equipment present within the working area 1 does not necessarily need to comprise an equipment appliance. Delimitation equipment 8, such as cones, are used to physically delimit and mark out the outer borders of primarily the working field 2, but also of possible traffic lanes 4, 5 and the working area 1. Examples of other equipment are signs, work sheds, piles of tyres, etc.

The positioning device of the equipment appliance, which, for instance, may consist of a positioning appliance known per se arranged to utilize known local or global positioning systems, is arranged to directly or indirectly communicate the position of the specific equipment appliance in relation to the working field 2 to the control system 3 in real-time, continuously or intermittently. Co-operation between the positioning device of the equipment appliance and the control system 3 also entails that a motion (speed and/or the direction) of the equipment appliance can be established in the control system 3. The communication may, for instance, take place via known wireless communications technique, wired communications technique, fibre-optic communications technique, etc., which are used in, for instance, mobile telephone networks, radio communications networks and/or positioning systems. With the purpose of obtaining the best possible positioning of the equipment appliances, a reference positioning device operatively connected to the control system 3 is preferably utilized for the calibration of the system.

### Detection Means

Furthermore, the system according to the invention comprises means for the detection of a near-accident situation and the type of the near-accident situation in question. The means for detection consists of at least one algorithm included in the control system 3 and intended for the detection of a near-accident situation and for the detection of the type of the same. Accordingly, said algorithm is an internal means for the detection of a near-accident situation. By algorithm, herein, reference is made to any form of logic calculation, formed by fixed rules and steps, which can be executed by the control system 3 based on the input data received by the control system 3 from the personal appliances and the digital representation of the working area 1, but also from, for instance, possible vehicle appliances, equipment appliances, external detection means that will be described hereinafter, etc.

Below, some examples follows of external means for the detection of a near-accident situation, i.e., means that assists with information to the above-mentioned internal means for the detection of a near-accident situation.

The means for the detection of a near-accident situation may consist of at least one radar appliance operatively connected with the control system 3 and, in co-operation with the control system, arranged to establish the position of unauthorized road-users as well as the speed and/or direction of motion thereof. Primarily, reference is made to road-user vehicles 9, and therefore the continued description is aimed at road-user vehicles 9, if nothing else is mentioned. The information from the radar appliance forms input data to the control system 3 for the detection of a near-accident situation. Said radar appliance may be realized by one or more radar devices.

Preferably, each individual road-user vehicle is observed and tracked during parts of or all the time that the same is present within the working area 1 and irrespective of if the same follows the existing traffic regulations, with the purpose of being able to detect a near-accident situation even if the road-user vehicle in itself is not the cause of the near-accident situation. Such a system may also detect and track maintenance vehicles that do not comprise any vehicle appliance, and that are authorized to temporarily be positioned within the working field 2 and/or the working area 1.

Furthermore, the means for the detection of a near-accident situation may consist of an automatic number or license plate reader operatively connected with the control system 3 and arranged to forward the car or registration number of the specific road-user vehicle 9 to the control system 3, the control system 3 further comprising data to identify the type, i.e., size, weight, etc., of the road-user vehicle 9 in question. In case the road-user vehicle 9 has a number plate that cannot be read or where the car number is not found in the control system 3, the specific road-user vehicle 9 is classified as, for instance, a heavy lorry. Thus, the information from the automatic number plate reader forms input data to the control system 3 for the detection of a near-accident situation. As an alternative or complement to the automatic number plate reader, means for reading the profile/size of the road-user vehicle 9 may, for instance, be used to establish the type of the road-user vehicle 9.

Furthermore, the means for the detection of a near-accident situation may consist of an emergency vehicle pre-warning system operatively connected with the control system 3. Such an emergency vehicle pre-warning system is arranged in such a way that at a point of time or distance before the emergency vehicle, which during its travel will need to pass through the working area 1 at the highest possible speed, enters into the working area 1, a pre-warning signal is forwarded to the control system 3. By emergency vehicle, reference is made to, for instance, ambulance vehicles, rescue service vehicles, police vehicles, etc. Thus, the information from the emergency vehicle pre-warning systems forms input data to the control system 3 for the detection of a near-accident situation. Accordingly, the workers 6 and/or the control system 3 can prepare for temporary increased passability in the working area 1. This may, for instance, be carried out by dynamic speed signs temporary displaying higher allowed speed through the working area 1, with the purpose of “emptying” the working area 1 of road-user vehicles 9 before the emergency vehicle enters into the working area 1. In working areas 1 where automatic or manual signal control/flag control is utilized, control of the road-user flow adapted to needs may also take place therein with the purpose of “emptying” the working area 1 of road-user vehicles before the emergency vehicle enters into the working area 1. Preferably, the pre-warning is forwarded 1-2 min before calculated entry into the working area 1, and this may take place automatically or manually from the emergency vehicle, or via a detection, for instance 2-5 km, before the working area 1.

### Road-User Appliance

The system according to the invention preferably also comprises a road-user appliance, not shown, operatively connected with the control system 3. The road-user appliance comprises information and sensation device for road-user vehicles, and is intended to be arranged before the working area 1, on the outer border of the working area 1 and/or in the working area 1. Examples of road-user appliances are dynamic speed signs, text signs, light units, physical obstacles, etc., which are arranged to receive expedient signals from the control system 3 in the event the driver of the road-user vehicle 9 should be warned upon a detected near-accident situation. For instance, the highest allowable speed displayed can temporary be lowered, a message such as “YOU ARE DRIVING TOO FAST” may be displayed, the current speed of the road-user vehicle may be displayed. Furthermore, a so-called flashing light or other light units may be activated. Traffic lights may be activated and switch over to red. Dynamic bumps may be activated. Furthermore, a warning may be transmitted via the radio unit of the road-user vehicle, or other equipment in the road-user vehicle.

Besides, unchangeable speed signs and information and warning signs may be utilized in the usual way in connection with the working area 1.

### Near-Accident Situation

In case a near-accident situation arises within a working field 2, to which only workers 6 and maintenance vehicles 7 have access, and only workers 6, maintenance vehicles 7 and/or equipment 8 are involved, the detection of the near-accident situation is made based on the signals received by the control system 3 from at least the personal appliances, the vehicle appliances, the equipment appliances and the digital representation of the working area 1. In a preferred embodiment, the control system 3 also receives input data regarding the current weather conditions at the working area 1.

Should there be a risk of collision if current positions and position changes are kept by the actors involved (workers 6, maintenance vehicles 7 and equipment 8), the same is detected as a near-accident situation. The fact that the control system 3 to a certain extent allows normal motion patterns of the actors is taken into account in the assessment made in the control system, which normal motion patterns thus do not cause detection of a near-accident situation. Next, or in parallel, a detection of the type of the near-accident situation is made, which at least includes establishment of who the involved actors are, with which probability a collision is inevitable, and calculated damage upon a collision. Establishment of who the actors are includes whether there are workers 6, maintenance vehicles 7 and/or equipment 8 involved in the near-accident situation as well as preferably, where applicable, establishment of the type of the maintenance vehicle 7. Establishment of with which probability a collision is inevitable is based on a combination of the position of the involved actors, and speed and/or the direction, as well as, where applicable, also the type of the maintenance vehicle 7.

In case a near-accident situation arises within a working area 1 to which workers 6, maintenance vehicles 7 and unauthorized road-users, such as road-user vehicles 9, have access, the detection of the near-accident situation is made based on the signals received by the control system 3 from at least the personal appliances, the vehicle appliances, the equipment appliances, the digital representation of the working area 1, as well as at least some of the above-mentioned external means for the detection of a near-accident situation. In a preferred embodiment, the control system 3 also receives input data regarding the current weather conditions at the working area 1.

Should there be a risk of collision if current positions and position changes are kept by the actors involved (workers 6, maintenance vehicles 7, equipment 8 and road-user vehicles 9), the same is detected as a near-accident situation. The fact that the control system 3 to a certain extent allows normal motion patterns of the actors is taken into account in the assessment made in the control system, which normal motion patterns thus do not cause detection of a near-accident situation.

Next, or in parallel, a detection of the type of the near-accident situation is made, which at least includes establishment of who the involved actors are, with which probability a collision is inevitable, and calculated damage upon a collision. Establishment of who the actors are includes whether there are workers 6, maintenance vehicles 7, equipment 8, and/or road-user vehicles 9 involved in the near-accident situation as well as preferably, where applicable, establishment of the type of the maintenance vehicle 7 and the type of the road-user vehicle 9. Establishment of with which probability a collision is inevitable is based on a combination of the position of the involved actors, and speed and/or the direction, as well as, where applicable, also the type of the maintenance vehicle 7 and the type of the road-user vehicle 9.

Based on the type of the detected near-accident situation, the control system carries out an assessment of the size of a risk area coupled to the near-accident situation. The established risk area may comprise several sections having mutually different risk levels in relation to the type of the near-accident situation. Besides, the size of the risk area may be different for workers 6 and maintenance vehicles 7, respectively.

In case a near-accident situation has been detected, the control system 3 is furthermore arranged to at least activate the sensation devices of the personal appliances the position of which is situated within the established risk area. Besides, also the sensation devices of the vehicle appliances the position of which is situated within the established risk area should preferably be activated. The sensation devices of the personal appliances and/or vehicle appliances that are present a section having a low risk level should preferably be given a weak activation, and the sensation devices of the personal appliances and/or vehicle appliances that are present in a section having a higher risk level should preferably be given a proportionally stronger activation. Besides, within the working field 2 or the working area 1, safety zones may exist in which the workers 6 and the maintenance vehicles 7 always are warned upon a detected near-accident situation. For instance, the area closest to the outer border of the working field 2, which borders on traffic lanes 4, 5, is classed as a safety zone. Other safety zones may be areas within the working field 2 having much noise and vibrations. Furthermore, the possible road-user vehicles 9 that are involved should be warned in a suitable way.

### Examples of a Near-Accident Situation in the Traffic

The working area 1 is a stationary, extended working place on/along a road, such as upon a pavement work or when mounting a guard rail, etc. The control system 3 is preferably, temporary, stationary situated in a suitable place in connection with the working area 1. In such a case, the workers 6 and the maintenance vehicles 7 may be positioned in the beginning, in the middle or in the end of the working field 2. In case the manoeuvre of a road-user vehicle 9 oncoming to the working area 1 causes a detection of a near-accident situation, in practice only workers 6 and maintenance vehicles 7 present in the beginning of the working field 2 are warned, provided that the same also are present in the established risk area. In case the manoeuvre of the road-user vehicle 9 still causes a detection of a near-accident situation when the same is present in the working area 1, in practice workers 6 and maintenance vehicles 7 present in the middle and in the end of the working area 1 are warned, provided that the same also are present in the established risk area. The road-user vehicle 9 is in practice warned repeatedly both before and in the working area 1.

The working area 1 is a mobile, limited working place on/along or adjacent to a road, such as upon maintenance work, road-mark painting, ditch cutting, snow clearing, road sweeping, etc. In such cases, the working area 1 moves concurrently with the workers 6 and the maintenance vehicles 7 moving. In such cases, the control system 3 is carried in a suitable maintenance vehicle 7. Thus, the working area 1 consists of a geographically delimited area that is stationary in relation to the maintenance vehicle 7.

The working area 1 is a stationary, limited working place on/along a road, such as upon rescue work carried out by the emergency service, the salvage corps, road assistance, etc., or upon limited repair and maintenance work on/along the road. In such cases, the control system 3 is carried in a suitable maintenance vehicle 7. Thus, the working area 1 consists of a geographically delimited area that is stationary in relation to the maintenance vehicle 7.

In case the manoeuvre of a road-user vehicle 9 oncoming to the limited working area 1 causes a detection of a near-accident situation, in practice all workers 6 and maintenance vehicles 7 present in the working area 1 are warned, provided that the same also are present in the established risk area.

It should be pointed out that unauthorized road-users, also when they move slowly or are standing still, may be involved in a near-accident situation. For instance, the same may take place upon work in a centrally situated traffic environment wherein persons or road-user vehicles may risk being hurt by reversing maintenance vehicles 7.

Furthermore, it should be pointed out that preferably it is always a near-accident situation when workers 6 or maintenance vehicles 7 are about to pass or pass the outer border of the working field 2, irrespective of whether it is a conscious or unconscious act, or if road-user vehicles 9 are present or not.

### Feasible Modifications of the Invention

The invention is not limited only to the embodiments described above and shown in the drawings, which only have the purpose of illustrating and exemplifying. This patent application is intended to cover all adaptations and variants of the preferred embodiments described herein, and consequently the present invention is defined by the wording of the accompanying claims and the equivalents thereof. Thus, the system may be modified in all feasible ways within the scope of the accompanying claims.

It should be pointed out that even if it is not explicitly mentioned that features from one specific embodiment can be combined with the features of another embodiment, this should be regarded as evident when possible.

1. System for detecting a near-accident situation in connection with a working area (1), comprising a control system (3) in which a digital representation of a working area (1) is storable, at least a part of the working area (1) consisting of a working field (2) in which work is intended to be carried out, means for the detection of a near-accident situation in connection with the working area (1) and the type of the same, which detection means consists of an algorithm included in the control system (3), at least one actor appliance operatively connected with the control system (3) and comprising a sensation device, as well as means for the establishment of the position of said at least one actor appliance, characterized in that the system furthermore comprises at least one external means for the detection of a near-accident situation in connection with the working area (1) and the type of the same, which external detection means is arranged to detect a near-accident situation where unauthorized road-user vehicles are involved, the control system (3), in case a near-accident situation has been detected, being arranged to activate the sensation device of said at least one actor appliance if the position of the actor appliance is situated within a risk area established in the control system, which establishment is based on the type of the detected near-accident situation.

2. System according to claim 1, characterized in that said actor appliance consists of a personal appliance in which the means for the establishment of the position of the personal appliance consists of a positioning device comprised in the personal appliance.

3. System according to claim 1, characterized in that the sensation device of said at least one personal appliance consists of a vibrator unit.

4. System according to claim 1, characterized in that said at least one personal appliance in addition comprises an identification device.

5. System according to claim 1, characterized in that the same comprises at least one vehicle appliance operatively connected with the control system (3) and comprising a positioning device.

6. System according to claim 5, characterized in that said at least one vehicle appliance comprises an identification device.

7. System according to claim 5, characterized in that said at least one vehicle appliance comprises a sensation device.

8. System according to claim 1, characterized in that the same comprises at least one equipment appliance operatively connected with the control system (3) and comprising a positioning device.

9. System according to claim 8, characterized in that said at least one equipment appliance is arranged in equipment (8) intended for physical indication of at least a part of the outer border of said working field (2).

10. System according to claim 1, characterized in that said means for detection in addition consists of at least one radar appliance operatively connected with the control system (3).

11. System according to claim 1, characterized in that the same comprises at least one road-user appliance operatively connected with the control system (3) and comprising at least one sensation device.

12. Method for detecting a near-accident situation in connection with a working area (1), comprising the steps of storing a digital representation of a working area (1) in a control system (3), at least a part of the working area (1) consisting of a working field (2) in which work is intended to be carried out, positioning an actor appliance operatively connected with the control system (3), and detecting a near-accident situation in connection with the working area (1) and the type of the same by means of an algorithm included in the control system (3), characterized by detecting, by means of an external detection means, a near-accident situation where unauthorized road-user vehicles are involved, the control system (3), in case a near-accident situation has been detected, activating a sensation device of said at least one actor appliance, if the position of the actor appliance is situated in a risk area established in the control system, which establishment is based on the type of the detected near-accident situation.

13. System according to claim 2, characterized in that the sensation device of said at least one personal appliance consists of a vibrator unit.

14. System according to claim 6, characterized in that said at least one vehicle appliance comprises a sensation device.
